(19) United States
(12) Patent Application Publication
(10) Pub. No.: US 2006/0280036 A1
(43) Pub. Date: Dec. 14, 2006

(54) Alarm clock with voice recorded and downloadable alarm tones

(76) Inventor: Melinda Hegarty, Tampa, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/398,427

(22) Filed: Apr. 5, 2006

Related U.S. Application Data
(60) Provisional application No. 60/688,881, filed on Jun. 10, 2005.

(51) Int. Cl. G04B 23/02

(52) U.S. Cl. 368/73

(57) ABSTRACT

A system for managing the downloading of selectable ring tones; a web interface for selecting a plurality of ring tones to be downloaded onto an alarm clock interface an alarm clock with a transmitter/receiver to selectively download at least one ring tone from the web interface, and for playing the ring tone at a selected time.

### CROSS REFERENCE TO RELATED CLAIMS

This application claims benefit to provisional application 60/688,881, filed on Apr. 5, 2005, entitled “Alarm Clock with Voice Recorded and Downloadable Alarm Tones.

### FIELD OF THE INVENTION

The present invention is directed to the field of alarm clocks. In particular, the present invention is directed to an alarm clock with voice recorded and downloadable alarm tones, messages, music or educational materials.

### BACKGROUND OF THE INVENTION

Millions of people worldwide rely upon alarm clocks to wake them up in the morning. Most alarm clocks have typically had a single ring tone. Other alarm clocks have allowed the user to set a radio station to wake them up.

There have been a number of patents directed to the area of alarm clocks with novel ring tones. U.S. Pat. No. 6,678,215 discloses an alarm clock radio that handles downloaded audio files and streaming digital audio files. The alarm clock radio may have buttons and displays that allow the user to adjust various alarm clock radio settings. The user may also adjust settings remotely over the Internet or over an in-home network. The user may customize the audio content that is provided with the alarm clock radio. Advertisements may be provided to the user. The user may be provided with an opportunity to subscribe to a content service. Content such as Internet radio station content, e-mail, news and other audio content may be provided to the user from the service.

The user may set reminders for particular times and dates using the alarm clock radio. The alarm clock radio may also have a telephone handset. The alarm clock radio may have buttons and knobs and may provide on-screen options that allow the user to tune to AM and FM and Internet radio stations and to control the operation of the alarm clock radio.

U.S. Patent Application No. 20020078818 discloses a device that plays sound data transmitted over a network based on a specified time. For example, the device can act as an alarm clock that plays a sound file received over the network. The disclosure also describes a server for transmitting sound data to the device. The server can communicate with the device over a public network such as the Internet or over a local network such as a home network.

U.S. Patent Application No. 20020099550 discloses an alarm clock with a variable alarm sound based on information provided by an external data source receives and processes a data file from an external source that contains information related to the alarm sound to be played upon activation of the alarm. When the alarm is triggered, the programmable controller accesses stored control programs, and plays audio content from sources available to it as described by the control programs. The received data file contains information that modifies the control programs of the microprocessor and affects the manner in which the alarm playback is conducted. A preferred embodiment is capable of receiving both programming instructions and data files from an Internet connection, and includes integrated sources of audio playback, a floppy data drive, a video display, and the capability of sending signals to an Internet web site.

It is an object of the present invention to provide a system for downloading ring tones.

It is a further object of the present invention to provide a system for downloading specific musical or similar downloads, including educational materials.

It is still a further object of the present invention to provide an alarm clock connected to a website.

It is further object of the present invention to provide a system whereby special sounds or noises can be downloaded and played for children and the like

These and other objects of the present invention will become apparent from the detailed description which follows.

### SUMMARY OF THE INVENTION

In accordance with the present invention, an alarm clock with downloadable tones comprising: a clock mechanism for maintaining time; an alarm mechanism associated with the clock; and means for accessing and downloading ring tones from a remote location to play on the clock in association with the alarm.

In a further embodiment, the invention is a system for managing the downloading of ring tones; a web interface for selecting a plurality of ring tones. An alarm clock with a transmitter/receiver to selectively download at least one ring tone from the web interface, and for playing the ring tone at a selected time.

In still a further embodiment, the invention is a system for managing the downloading of selectable ring tones; a web interface for selecting a plurality of ring tones to be downloaded onto an alarm clock interface; and an alarm clock with a transmitter/receiver to selectively download at least one ring tone from the web interface, and for playing the ring tone at a selected time.

In still yet a further embodiment, the invention is a system for managing the downloading of selectable ring tones or messages for an alarm clock; a web interface for selecting a plurality of ring tones to be downloaded onto an alarm clock interface via a wireless connection an alarm clock with a transmitter/receiver to selectively download a plurality of alarm tones or pre-selected presentations from the web interface, and for playing the alarm tones or pre-selected presentation at a selected time.

### BRIEF DESCRIPTION OF THE DRAWINGS

FIG. 1 is a block diagram of the present invention.

FIG. 2 is a diagram of an internet website in accordance with the present invention.

FIG. 3 illustrates a block diagram of the alarm clock of the present invention.

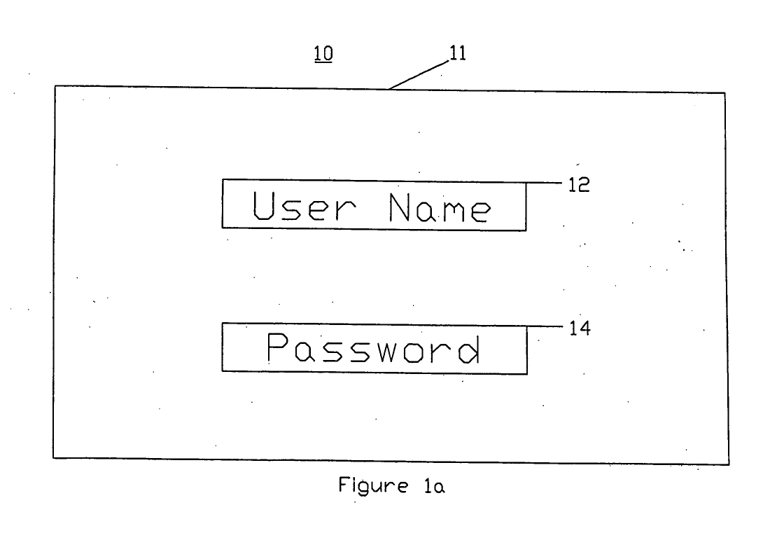

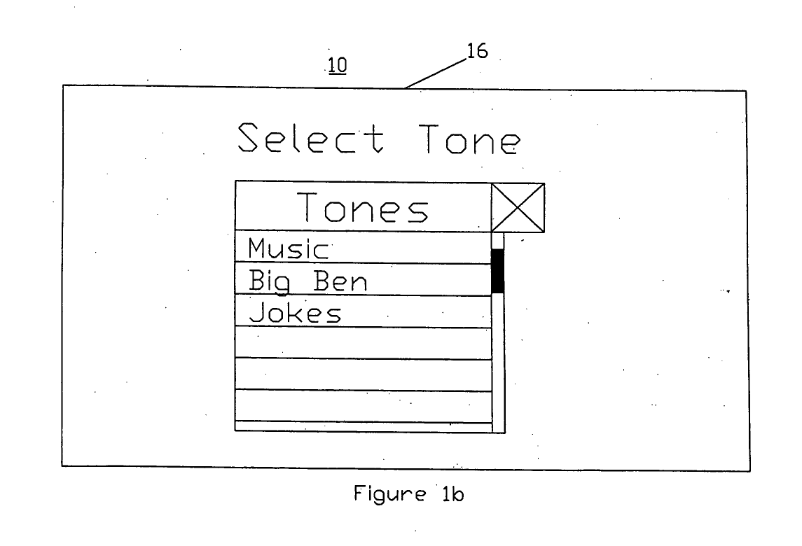

### DESCRIPTION OF THE PREFERRED EMBODIMENT

The present invention is described with reference to the attached Figures. The present invention is directed to a system for permitting the downloading and playing of individualized ring tones for an alarm clock. In a most preferred embodiment, the invention comprises a system 10 for downloading tones via the Internet and which can be played at the discretion of the user.

In a most preferred embodiment, the system comprises an online web service. The system includes a website 10 with an input page 11. The page facilitates the creation of user names 12, passwords 14, and input screens 16. The end users will create or pick a series of end user tones which can be downloaded to an alarm clock.

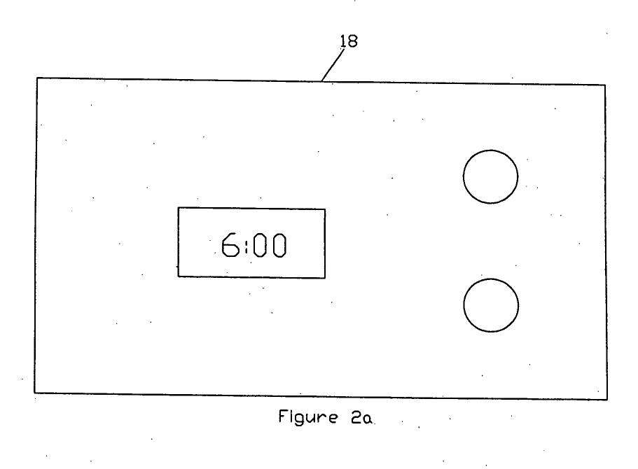

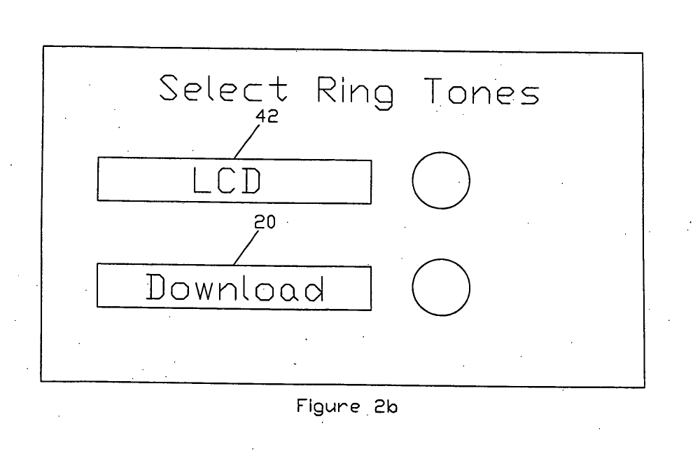

As shown in FIG. 2, the invention comprises an alarm clock 18. The clock 18 has a wireless transmitter interface 20. The interface allows an alarm clock to download a plurality of ring tones. In a most preferred embodiment, the system provides a system where the website can be used to download and access a plurality of web files, each corresponding to a ring tone. The ringtone cam comprise unique or historic sounds (e.g. Big Ben in the UK; Notre Dame Cathedral in Paris; or popular music or show tunes

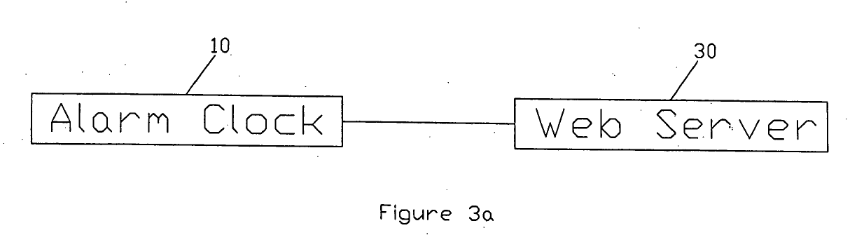

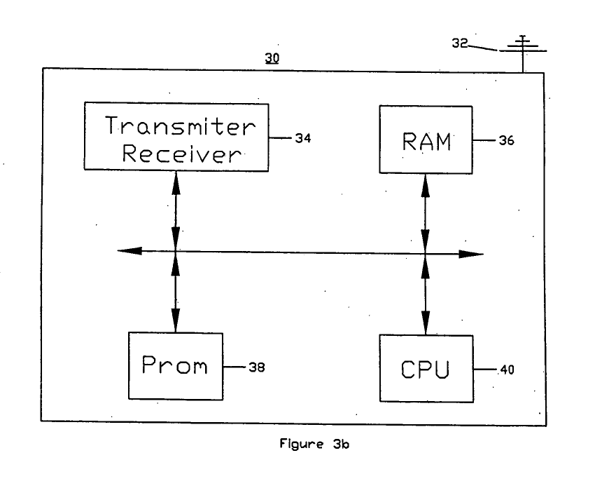

Referring to FIGS. 3a and 3b, the alarm clock connects to a website 30. A connection is made with the website via T-1, dial up connection or wireless connection 32. By means of the website, a plurality of alarm signal can be downloaded and stored and then uploaded or directly transmitted to the alarm clock for storage. The signal may be transmitted via a telephone or wireless connection. It will be stored and played at the appropriate time.

The invention can thus be used to download tones such as cartoon character's sounds and similar greetings. Children can receive personalized messages from cartoon characters such as “Spongebob Squarepants” or Mickey Mouse.

Referring more specifically to FIG. 3, the alarm clock has a number of features, including a transmitter and receiver 34, RAM 36 , PROM, 38 and processor 40. The transmitter/receiver accesses an IP code and can download a file to be stored. The clock will preferably include an LCD 42 display which will enable the end user to pre-store and select specific ring tones, messages, music or sounds.

In operation, when the end user desires to select a ring tone, the alarm clock can access and download specific files via the website. When the alarm is set, the specific ring tone is selected from a menu via LCD display 42.

When the alarm is to be activated, the selected tone, music, noise or character sound is played. Important information, such as educational material or scheduling can also be downloaded and played included.

The present invention has been described with reference to the enclosed Figures and detailed description. It is to be appreciated that the true nature and scope of the invention is to be determined with reference to the claims appended hereto.

1. An alarm clock with downloadable tones comprising:
a clock mechanism for maintaining time;
an alarm mechanism associated with the clock; and
means for accessing and downloading ring tones from a remote location to play on the clock in association with the alarm.

2. A system for managing the downloading of ring tones;
a web interface for selecting a plurality of ring tones;
an alarm clock with a transmitter/receiver to selectively download at least one ring tone from the web interface, and for playing the ring tone at a selected time.

3. A system for managing the downloading of selectable ring tones;
a web interface for selecting a plurality of ring tones to be downloaded onto an alarm clock interface;
an alarm clock with a transmitter/receiver to selectively download at least one ring tone from the web interface, and for playing the ring tone at a selected time.

4. A system for managing the downloading of selectable ring tones; a web interface for selecting a plurality of ring tones to be downloaded onto an alarm clock interface via a wireless connection
an alarm clock with a transmitter/receiver to selectively download a plurality of alarm tones or pre-selected presentations from the web interface, and for playing the alarm tones or pre-selected presentation at a selected time.
